(19) United States
(12) Patent Application Publication
(10) Pub. No.: US 2009/0193133 A1
(43) Pub. Date: Jul. 30, 2009

(54) NETWORK DEVICE MANAGEMENT APPARATUS, CONTROL METHOD THEREFOR, NETWORK SYSTEM, AND STORAGE MEDIUM

(75) Inventor: Minoru Torii, Irvine, CA (US)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/359,202

(22) Filed: Jan. 23, 2009

(30) Foreign Application Priority Data
Jan. 24, 2008 (JP) 2008-014056

(51) Int. Cl. G06F 15/16

(52) U.S. Cl. 709/230

(57) ABSTRACT

A network device management apparatus which is capable of constructing a network environment in which excellent operability is maintained without displaying a communication error screen even in a case where different protocols, such as IPv4 and IPv6, are mixedly used on a network, or between network apparatuses operating on a specific protocol, such as IPv6. A network device management apparatus is communicably connected to a device and a client apparatus on a network. A network device management application receives a request for access to the device from the client apparatus. The application acquires an address of the client apparatus and an address of the device. If communication between the client apparatus and the device is impossible, the application sends device information acquired from the device to the client apparatus, whereas if the communication is possible, the application sends an address for connection to the device to the client apparatus.

### BACKGROUND OF THE INVENTION

1. Field of the Invention

The present invention relates to a network device management apparatus and method capable of communicating with a device. More specifically, constructing a network environment in which excellent operability is maintained.

2. Description of the Related Art

As a protocol for use in communication with a network device, there has been used IPv4 (Internet Protocol version 4). IPv4 is a protocol located in a network layer defined in the OSI (Open System Interconnection) reference model, and uses 32-bit addresses, defining an address space in which it is used for addressing, routing, and error control.

Recently, a problem has occurred the 32-bit address space is running short due to an increase in devices connected to networks with the widespread use of the Internet. To solve this problem, IPv6 (Internet Protocol version 6) having an address space expanded to 128 bits has been developed and is being progressively introduced.

In the case of an IPv6 global unicast address which is currently generally used for IPv6, the 128-bit address format is composed of two parts: a network address portion (subnet prefix) formed of the most significant 64 bits and an interface ID formed of the least significant 64 bits. The most significant 64-bit subnet prefix is composed of a global routing prefix and a subnet ID.

Differences between three types of addresses, i.e. a stateful address, a stateless address, and a link local address, can be represented by differences between the network address. The stateful address is an IPv6 address acquired from a DHCP server using the DHCPv6 protocol. DHCP is an abbreviation for Dynamic Host Configuration Protocol. The stateless address is an IPv6 address automatically generated by an IPv6 apparatus based on information sent from a router. The link local address is an IPv6 address that makes communication possible only within a network where the IPv6 apparatus belongs (the same link). Each IPv6 apparatus can have a plurality of addresses of the above-mentioned types set thereto.

On the other hand, as a network device management apparatus for managing devices, such as image processing apparatuses, in an IPv4 network environment, there has been proposed one in Japanese Patent Laid-Open Publication No. 2003-330824, for example.

This network device management apparatus searches for network devices connected to the network and displays a list of the devices. A user selects a device to be managed from the device list and monitors the status, including error information, of the device. Status information on the device is periodically acquired by the network device management apparatus. Further, the user changes the network configuration of each device for management. For example, the user changes the IP address of the device. At this time, the network device management apparatus changes the configuration of the device, using SNMP/MIB. SNMP is an abbreviation for Simple Network Management Protocol, and MIB is an abbreviation for Master Information Block.

According to Japanese Patent Laid-Open Publication No. 2003-330824, when the network device incorporates a Web server, a client apparatus on which a Web browser operates directly accesses the Web server of the network device management apparatus, and acquires device information and displays the same on the Web browser. On the other hand, when the network device does not incorporate a Web server, the client apparatus requests the network device management apparatus to collect MIB information from the device, using the SNMP protocol. Then, the client apparatus receives the device information acquired by the network device management apparatus, and displays the information on the Web browser.

In the above-mentioned Japanese Patent Laid-Open Publication No. 2003-330824, however, it is assumed that a device on the network and the client apparatus on which the Web browser operates communicate with each other using IPv4, but an environment in which IPv4 and IPv6 are mixedly used, or a network device operating on IPv6 which permits a plurality of addresses set thereto is not taken into consideration.

More specifically, when a browser operates with IPv4, and a device operates with IPv6, or vice versa, the browser and the device cannot communicate with each other, and hence a communication error screen is displayed on the browser (see FIG. 19A).

Further, also in an environment where both a browser and a device operate with IPv6, it is impossible to select an address which makes possible communication between them from a plurality of IPv6 addresses set to the device. For this reason, there also arises a problem that the communication error screen is displayed on the browser (see FIG. 19B).

### SUMMARY OF THE INVENTION

An object of the present invention is to provide a network device management apparatus, a control method therefor, a network system, and a storage medium storing a program for implementing the control method, which are capable of constructing a network environment in which excellent operability is maintained without displaying a communication error screen even in a case where different protocols, such as IPv4 and IPv6, are interchangeably used on a network, or between network apparatuses operating on a specific protocol, such as IPv6.

In a first aspect of the present invention, there is provided a network device management apparatus communicably connected to a device and a client apparatus on a network, comprising a reception unit configured to receive an access request for access to the device from the client apparatus, a first acquisition unit configured to acquire information which makes it possible to identify a communication protocol used by the client apparatus, when the access request is received by the reception unit, a second acquisition unit configured to acquire information which makes it possible to identify a communication protocol used by the device, from the device, a determination unit configured to determine, based on the information acquired by the first and second acquisition units, whether communication between the client apparatus and the device is possible, a first transmission unit configured to send device information acquired from the device by the network device management apparatus to the client apparatus, when the determination unit does not determine that communication between the client apparatus and the device is possible, and a second transmission unit configured to send an address for connection to the device to the client apparatus, when the determination unit determines that communication between the client apparatus and the device is possible.

In a second aspect of the present invention, there is provided a network device management apparatus including a device search unit that searches for a device on a network, and an information acquisition unit that acquires, from the device found by the device search unit, information on the device, the network device management apparatus being communicably connected to the device and a client apparatus on the network, comprising a unit configured to receive an access request for access to the device from the client apparatus, a unit configured to acquire an address of the client apparatus, which is defined by a first protocol as a communication protocol used by the client apparatus or a second protocol obtained by updating a version of the first protocol, when the access request is received, a unit configured to acquire a list of addresses of the device, which is defined by the first protocol or the second protocol used by the device, from the information on the device acquired by the information acquisition unit, and a unit configured to make a comparison between the acquired address of the client apparatus and the addresses of the device, and send the acquired list of the addresses of the device to the client apparatus when the client apparatus and the device are both operating on the second protocol.

In a third aspect of the present invention, there is provided a method of controlling a network device management apparatus communicably connected to a device and a client apparatus on a network, comprising receiving an access request for access to the device from the client apparatus, acquiring information which makes it possible to identify a communication protocol used by the client apparatus, when the access request is received, acquiring information which makes it possible to identify a communication protocol used by the device, from the device, determining, based on the acquired information which makes it possible to identify a communication protocol used by the client apparatus and the acquired information which makes it possible to identifying a communication protocol used by the device, whether communication between the client apparatus and the device is possible, sending device information acquired from the device by the network device management apparatus to the client apparatus, when it is not determined that communication between the client apparatus and the device is possible, and sending an address for connection to the device, to the client apparatus, when it is determined that communication between the client apparatus and the device is possible.

In a fourth aspect of the present invention, there is provided a network system including a device, a client apparatus, and a network device management apparatus on a network, the network device management apparatus being communicably connected to the device and the client apparatus, wherein the network device management apparatus comprises a reception unit configured to receive an access request for access to the device from the client apparatus, a first acquisition unit configured to acquire information which makes it possible to identify a communication protocol used by the client apparatus, when the access request is received by the reception unit, a second acquisition unit configured to acquire information which makes it possible to identify a communication protocol used by the device, from the device, a determination unit configured to determine, based on the information acquired by the first and second acquisition units, whether communication between the client apparatus and the device is possible, a first transmission unit configured to send device information acquired from the device by the network device management apparatus to the client apparatus, when the determination unit does not determine that communication between the client apparatus and the device is possible, and a second transmission unit configured to send an address for connection to the device to the client apparatus, when the determination unit determines that communication between the client apparatus and the device is possible.

In a fifth aspect of the present invention, there is provided a computer-readable storage medium storing a program for causing a computer to execute a method of controlling a network device management apparatus communicably connected to a device and a client apparatus on a network, wherein the method comprises receiving an access request for access to the device from the client apparatus, acquiring information which makes it possible to identify a communication protocol used by the client apparatus, when the access request is received, acquiring information which makes it possible to identify a communication protocol used by the device, from the device, determining, based on the acquired information which makes it possible to identify a communication protocol used by the client apparatus and the acquired information which makes it possible to identifying a communication protocol used by the device, whether communication between the client apparatus and the device is possible, sending device information acquired from the device by the network device management apparatus to the client apparatus, when it is not determined that communication between the client apparatus and the device is possible, and sending an address for connection to the device, to the client apparatus, when it is determined that communication between the client apparatus and the device is possible.

According to the present invention, it is possible to construct a network environment in which excellent operability is maintained without displaying a communication error screen even in a case where different protocols are mixedly used on a network, or between network apparatuses operating on a specific protocol.

The features and advantages of the invention will become more apparent from the following detailed description taken in conjunction with the accompanying drawings.

### BRIEF DESCRIPTION OF THE DRAWINGS

FIG. 1 is a schematic diagram of the configuration of a network system including a network device management apparatus according to a first embodiment of the present invention.

FIG. 2 is a block diagram of the configuration of a device formed by an image processing apparatus.

FIG. 3 is a view of an IPv6 configuration screen of the device.

FIG. 4 is a block diagram of the configuration of each of the network device management apparatus and a client apparatus.

FIG. 5 is a block diagram of the configuration of a device management application.

FIG. 6 is a view of a device list screen displayed by the device management application.

FIG. 7 is a sequence diagram of a sequence of operations of the network system including the network device management apparatus according to the first embodiment.

FIG. 8 is a view of an example of a RUI screen displayed on a browser.

FIG. 9 is a view of an example of a device detail screen displayed on the browser.

FIG. 10 is a flowchart showing the outline of a device management process which is executed by the device management application installed in the network device management apparatus according to the first embodiment.

FIG. 11 is a flowchart showing details of processing carried out in a step S1-6 in FIG. 10.

FIGS. 12A and 12B are flowcharts showing details of a first determination process (S2-8) in FIG. 11.

FIG. 13 is a flowchart showing details of a first example of a second determination process (S2-12) in FIG. 11.

FIG. 14 is a flowchart showing details of a second example of the second determination process (S2-12) in FIG. 11.

FIG. 15 is a flowchart showing details of a third example of the second determination process (S2-12) in FIG. 11.

FIG. 16 is a flowchart of the outline of a device management process which is executed by a device management application installed in a network device management apparatus according to a second embodiment of the present invention.

FIG. 17 is a view of an example of an address selection screen.

FIG. 18 is a sequence diagram of a sequence of operations of a network system including a network device management apparatus according to a third embodiment of the present invention.

FIGS. 19A and 19B are schematic diagrams of configurations of conventional network systems.

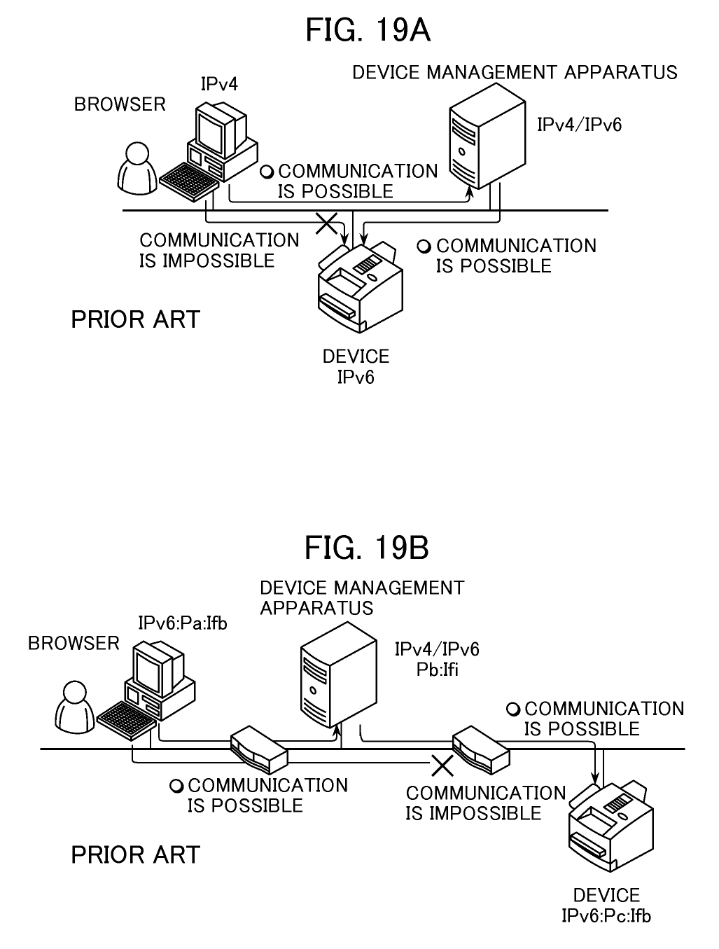

### DETAILED DESCRIPTION OF THE EMBODIMENTS

The present invention will now be described in detail below with reference to the accompanying drawings showing embodiments thereof.

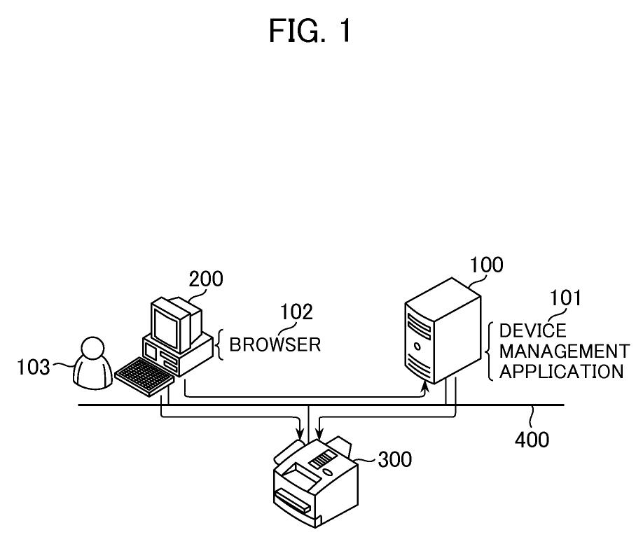

FIG. 1 is a schematic diagram of a network system including a network device management apparatus according to a first embodiment of the present invention.

This network system includes the network device management apparatus 100, a client apparatus 200 implemented by a personal computer (PC), and a device 300 as an image processing apparatus, all of which are interconnected via a network 400, such as a LAN.

A device management application 101 is installed in the network device management apparatus 100 for operating thereon, while a browser 102 operates on the client apparatus 200.

The browser 102 operates as a Web browser on the client apparatus 200 operated by an IT administrator 103. The IT administrator 103 uses the browser 102 to manage devices existing on the network 400, from a remote place. For example, the IT administrator 103 acquires respective statuses of devices, detects a device in which an error has occurred, and recovers the error in the device to place the same in a state capable of performing a printing operation.

The device management application 101 manages the devices (including the device 300) on the network 400 in response to requests from the browser 102. More specifically, the device management application 101 acquires device information from a device in response to a device information acquisition request from the browser 102, or changes settings of a device to appropriate values in response to a device configuration change request from the browser 102.

For example, the device 300 is an image processing apparatus existing on the network 400, and sends device information or changes settings thereof, in response to a request from the device management application 101. Further, the device 300 transmits HTML data including the device information in response to a Web page display request from the browser 102.

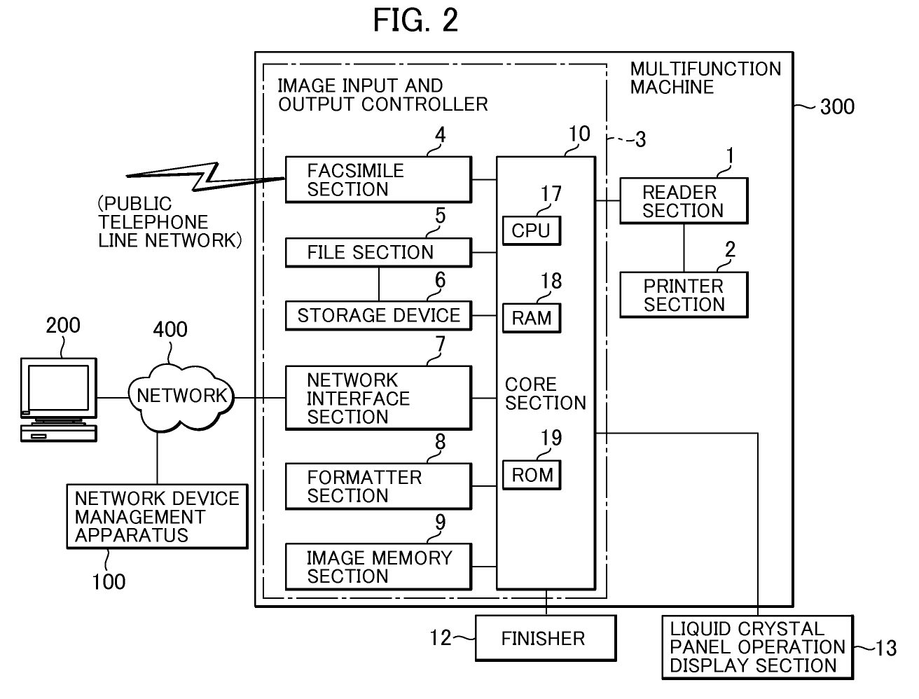

FIG. 2 is a block diagram of the configuration of the device 300 formed by an image processing apparatus.

The device 300 is mainly comprised of a reader section 1, a printer section 2, and an image input and output controller 3. The reader section 1 is connected to the printer section 2 and the image input and output controller 3. The reader section 1 reads an image from an original and outputs the read image data to the printer section 2 or the image input and output controller 3. The printer section 2 prints the image data output from the reader section 1 and the image input and output controller 3 on a recording sheet. The image input and output controller 3 is connected to a finisher 12 for causing the same to perform predetermined processing, such as stapling, on a printout delivered from the printer section 2. The image input and output controller 3 is connected to a liquid crystal panel operation display section 13, for displaying an operational status of the device (multifunction machine) 300 and enabling instructions to be input by the user. Further, the image input and output controller 3 is connected to an external network 400 or a public telephone line to perform input and output of image data.

The image input and output controller 3 is comprised of a facsimile section 4, a file section 5, a storage device 6, a network interface section 7, a PDL formatter section 8, an image memory section 9, and a core section 10. The file section 5 is connected to the core section 10 and the storage device 6, and compresses image data received from the core section 10 and then stores the compressed image data in the storage device 6 together with a keyword for use in retrieving the image data. The storage device 6 stores not only image data, but also application programs to be executed by a CPU 17, etc.

The network interface section 7 provides interface between the network device management apparatus 100 or the client apparatus 200 connected to the network interface section 7 via the external network 400 and the core section 10. It is assumed that the network interface section 7 incorporates a Web server.

The formatter section 8 is connected to the core section 10, and converts PDL data received from the client apparatus 200 into image data printable by the printer section 2. The image memory section 9 temporarily stores read-in image information from the reader section 1 and image information received e.g. from the client apparatus 200 via the network interface section 7.

The core section 10 controls data flowing between the above-mentioned reader section 1, the facsimile section 4, the file section 5, the network interface section 7, and the formatter section 8. Further, the core section 10 analyzes job control data and performs control such that information concerning user use conditions, the number of sheets for copying, printing, or scanning, and so forth is accumulated in a RAM 18 or the storage device 6. The core section 10 also performs image processing, such as zooming, rotation, resolution conversion, or format conversion, on image data. The CPU 17 of the core section 10 loads application programs stored in a ROM 19 or the storage device 6 into the RAM 18 and executes these to thereby control the overall operation of the image input and output controller 3.

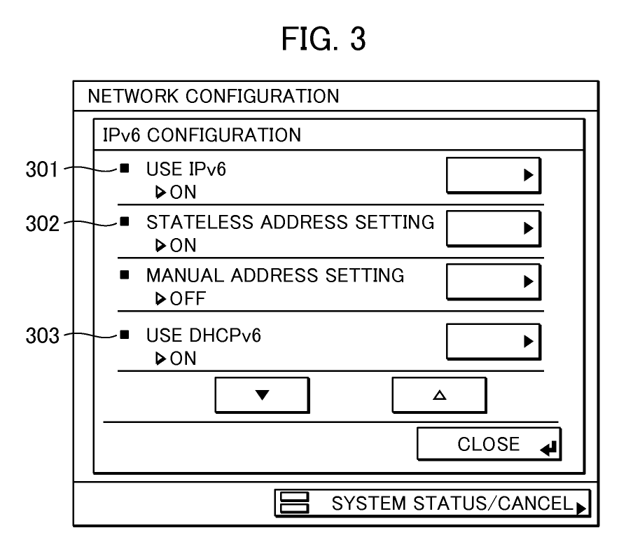

FIG. 3 is a view of an IPv6 configuration screen of the device 300.

An IPv6 (second protocol) function of the device 300 can be activated by setting an item “Use of IPv6” 301 to ON. FIG. 3 shows an exemplary case where a stateless address and a stateful address (Use of DHCIPv6 protocol) are activated as shown in respective items 302 and 303. In the present example of the device 300, it is assumed that five stateless addresses and one stateful address are set.

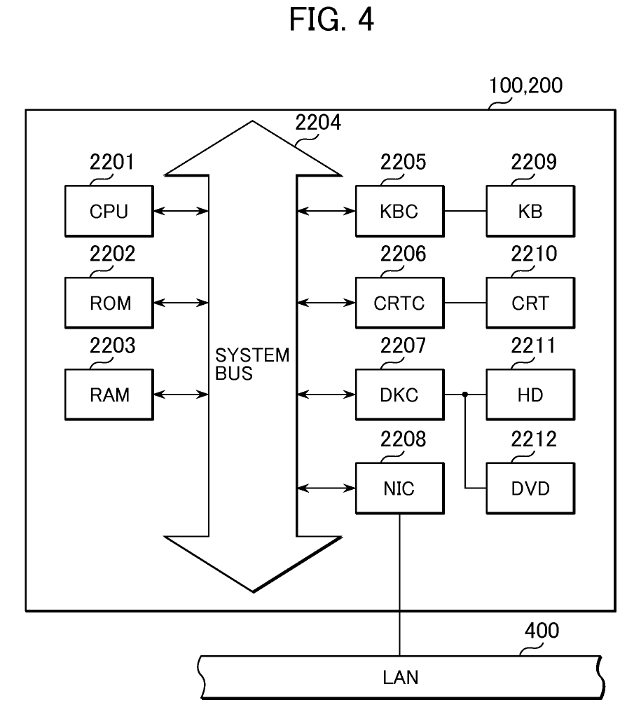

FIG. 4 is a block diagram of the configuration of each of the network device management apparatus 100.

The network device management apparatus 100 is provided with a CPU 2201 that executes various programs, and the CPU 2201 is connected to various hardware modules via a system bus 2204.

More specifically, a ROM 2202 and a RAM 2203 are connected to the system bus 2204. Further, a hard disk (HD) 2211 is connected to the system bus 2204 via a disk controller (DKC) 2207. The ROM 2202 or the hard disk (HD) 2211 stores programs including the device management application 101 as a main control program of software of the network device management apparatus 100 according to the present embodiment. The RAM 2203 is used as a main memory and a work area of the CPU 2201.

It should be noted that the device management application 101 may be supplied in a state of being stored in a storage medium, such as a DVD or a CD-ROM. In this case, the program is read from the storage medium e.g. by a DVD controller (DVD) 2212 appearing in FIG. 4 or a CD-ROM drive, not shown, and is installed in the hard disk (HD) 2211.

Further, connected to the system bus 2204 is a network interface card (NIC) 2208. The network interface card 2208 bidirectionally exchanges data with an external network apparatus, such as the client apparatus 200 or the device 300, via the LAN 400.

Furthermore, a keyboard controller (KBC) 2205 and a CRT controller (CRTC) 2206 are connected to the system bus 2204. The keyboard controller (KBC) 2205 controls instruction inputs from a keyboard (KB) 2209, a pointing device, not shown, and so forth. The CRT controller (CRTC) 2206 controls display of a CRT display (CRT) 2210.

As shown in FIG. 4, the client apparatus 200 is identical in configuration to the network device management apparatus 100. However, the client apparatus 200 is different from the network device management apparatus 100 in that the hard disk (HD) 2211 stores the browser 102.

Next, a description will be given of the device management application 101.

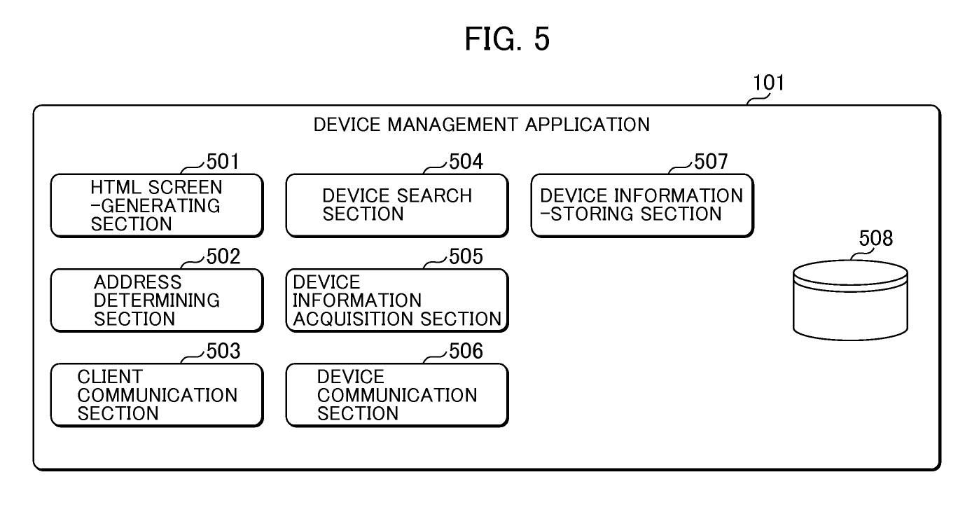

FIG. 5 is a block diagram of the configuration of the device management application 101.

The device management application 101 is comprised of an HTML screen-generating section 501, an address determining section 502, a client communication section 503, a device search section 504, a device information acquisition section 505, a device communication section 506, and a device information-storing section 507.

The HTML screen-generating section 501 generates HTML data to be output to the browser 102. The address determining section 502 makes a comparison between an address acquired from the client apparatus 200 on which the browser 102 is operating and the addresses acquired from the device 300, to thereby select an address that makes communication possible. These addresses are defined by IPv4 or IPv6 as an update version of IPv4.

The client communication section 503 performs acquisition of the address set in the client apparatus 200 on which the browser 102 is operating, and transmission and reception of HTML data.

The device search section 504 searches for devices on the network and stores information on the devices in a database 508. The device search section 504 acquires all IP address information, ON/OFF setting information on IPv4 and IPv6, an IPv6 address type (stateless, stateful, or link local), and an FQDN, which are set for each device at the time of the search, and stores these in the database 508. The device information acquisition section 505 acquires information on a device, such as the IP address, location information, and an option configuration of the device. The device communication section 506 communicates with the device using protocols, such as SNMPv1, SNMPv3, and Web service. The device information-storing section 507 stores the information acquired from the device in the database 508.

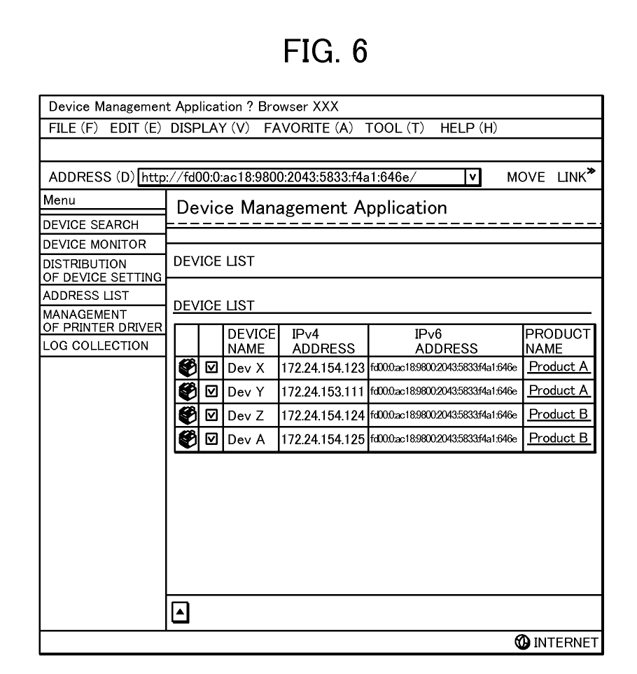

FIG. 6 is a view of a device list screen displayed by the device management application 101.

A device list on the screen is displayed by acquiring device information stored in the database 508 by the device search section 504.

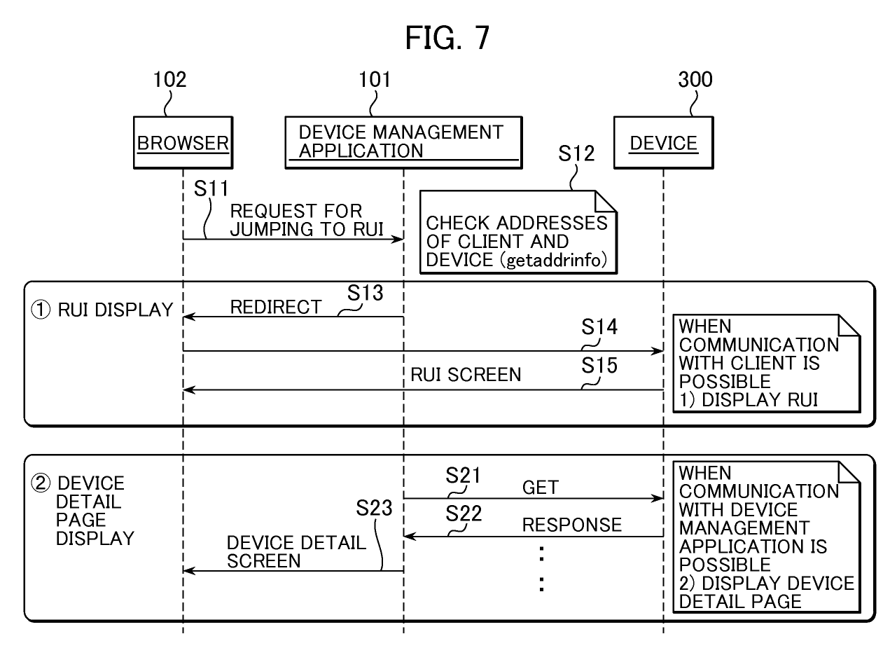

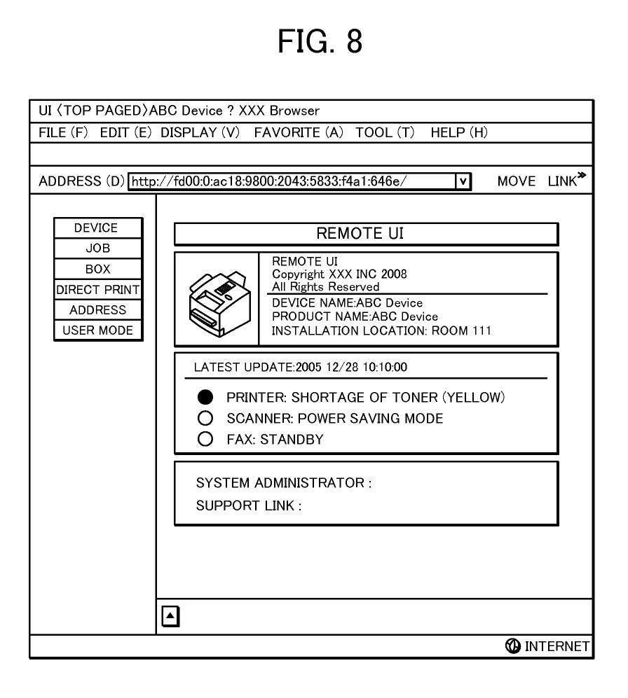

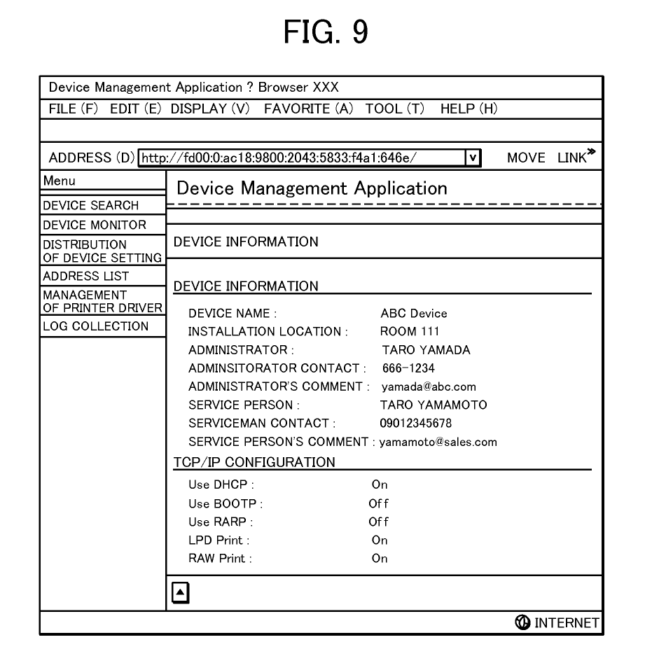

FIG. 7 is a sequence diagram of the sequence of operations of the network system including the network device management apparatus 100 according to the first embodiment, i.e. the sequence of operations carried out between the browser 102, the device management application 101, and the device 300. Further, FIG. 8 is a view of an example of a RUI screen displayed on the browser 102, and FIG. 9 is a view of an example of a device detail screen displayed on the browser 102.

The IT administrator 103 manages the devices on the network 400 via the browser 102. The device list is displayed on the browser 102 to show the devices to be managed in a list form. The IT administrator 103 accesses the Web server incorporated in the specific device 300, so as to refer to detail information on the device 300, and attempts to cause the Web server to display device information (hereinafter referred to as the RUI) shown in FIG. 8. RUI is an abbreviation for Remote User Interface.

At this time, the browser 102 sends an RUI display request (access request) to the device management application 101 (S11). The device management application 101 compares the address of the client apparatus 200 on which the browser 102 is operating with that of the device 300 where the RUI as a jump destination exists, and determines whether communication between the browser 102 and the device 300 is possible (S12).

If communication between the browser 102 and the device 300 is possible, the device management application 101 sends a redirect request to the browser 102 so as to redirect the browser 102 to the address of the device 300 with which the browser 102 can communicate (S13). The redirect request is a kind of HTTP response from the server, which notifies the browser 102 that a URL has been changed. It should be noted that HTTP is an abbreviation for Hyper Text Transfer Protocol, and URL is an abbreviation for Uniform Resource Locator. Thereafter, the device 300 accepts the RUI display request from the browser 102 (S14), and sends HTML data of the RUI screen (see FIG. 8) back to the browser 102 (S15).

On the other hand, if communication between the browser 102 and the device 300 is impossible, the device management application 101 acquires information from the device 300 using the protocol, such as SNMPv1, SNMPv3, or Web service, by which the browser 102 can communicate with the device 300 (S21 and S22). Then, the device management application 101 generates the device detail screen (see FIG. 9) and sends the generated screen back to the browser 102 (S23).

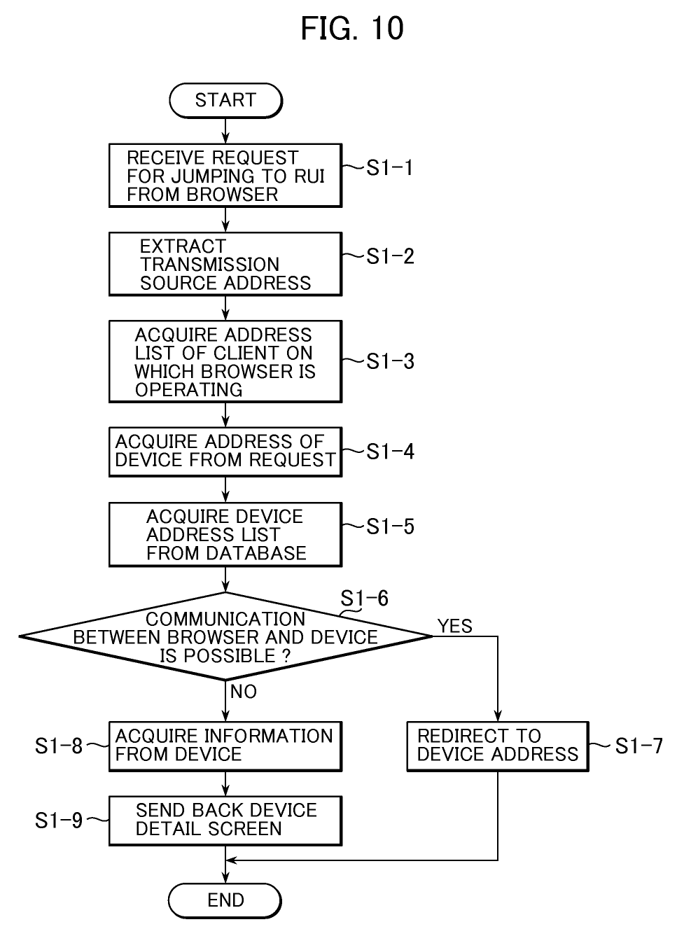

Next, a device management process which is executed as illustrated in the FIG. 7 sequence by the device management application 101 installed in the network device management apparatus 100 according to the present embodiment will be described with reference to flowcharts in FIGS. 10 to 14.

FIG. 10 is a flowchart showing the outline of the device management process executed by the device management application 101 installed in the network device management apparatus 100 according to the first embodiment.

First, in a step S1-1, the device management application 101 receives a request for jumping to the RUI of the device 300, from the browser 102. In the following step S1-2, the device management application 101 extracts a transmission source address (i.e. the address of the PC (client apparatus 200) on which the browser 102 is operating) from request data indicative of the request for jumping to the RUI.

In the following step S1-3, the device management application 101 acquires a list of addresses set for the client apparatus 200 on which the browser 102 is operating, which were stored in the database during the device search, e.g. using the getaddrinfo function (first acquisition process). Further, in a step S1-4, the device management application 101 acquires the address of the device 300 from the request data indicative of the request for jumping to the RUI (second acquisition process). Furthermore, in a step S1-5, the device management application 101 acquires a list of addresses of the device 300, which were stored during the device search, from the database 508, e.g. using the getaddrinfo function, similarly to the above.

Then, in a step S1-6, the device management application 101 determines whether communication between the browser 102 and the device 300 is possible. This determination in the step S1-6 will be described in detail hereinafter.

If communication between the browser 102 and the device 300 is possible, the process proceeds to a step S1-7, wherein the device management application 101 performs redirection to the address of the device 300 with which the browser 102 can communicate. Specifically, the item “Use of IPv6” 301 is set to ON, and an HTTP response having “http://(address of the device 300 with which the browser 102 can communicate)” set as “Location” is sent back to the browser 102. The browser 102 having received the redirect request can communicate with the device 300 and display the RUI screen.

If communication between the browser 102 and the device 300 is impossible, the process proceeds to a step S1-8, wherein the device management application 101 acquires device information including e.g. status information and installation location information, using a protocol, such as SNMPv1, SNMPv3, or Web service. At this time, the device management application 101 uses an address which the device 300 used for sending back a response during the device search.

In a step S1-9, the device management application 101 converts the device information acquired from the device 300 into HTML data of a device detail screen, and then sends the HTML data to the browser 102 (first transmission process). The browser 102 having received the HTML data can display the device detail screen.

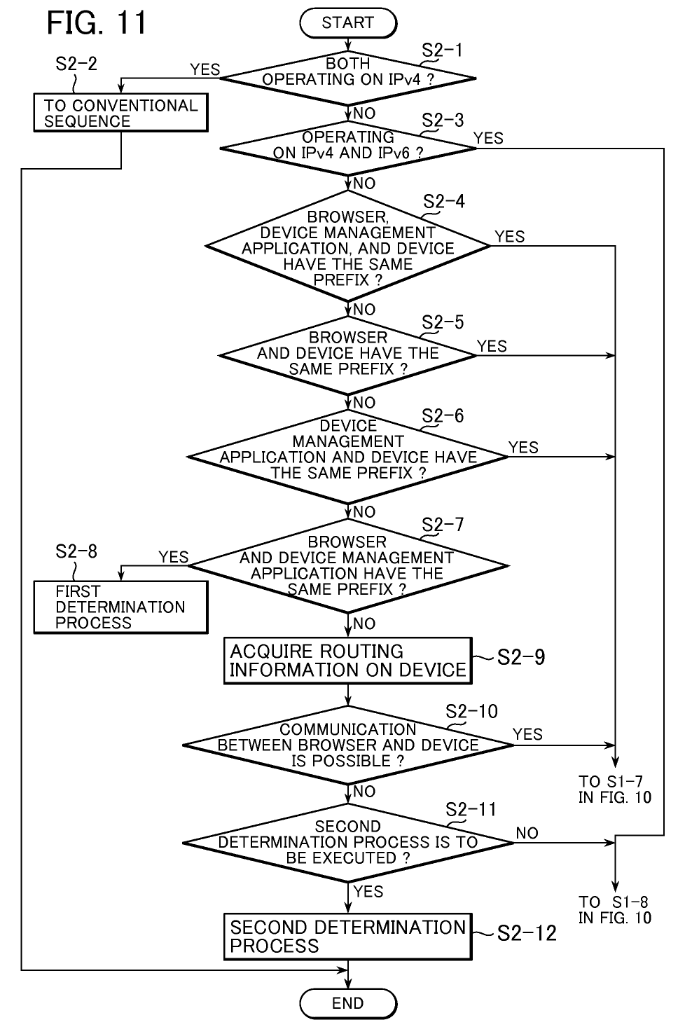

Next, details of the processing in the step S1-6 in FIG. 10 will be described in detail with reference to a flowchart in FIG. 11.

First, in a step S2-1, the device management application 101 checks whether the browser 102 and the device 300 are both operating on IPv4. The address of the browser 102 is acquired from the transmission source address of the HTTP request. The IP address of the device 300, which was acquired during the device search, has been stored in the database 508.

The device management application 101 makes a comparison between the address of the browser 102 and that of the device 300 to thereby determine whether the browser 102 and the device 300 are both operating on IPv4 (first protocol). If the browser 102 and the device 300 are both operating on IPv4, the process proceeds to a step S2-2, wherein the device management application 101 executes the conventional sequence (corresponding to the steps S1-7 to S1-9 in FIG. 10), followed by terminating the present process.

In the conventional sequence, when the device 300 incorporates a Web server, the device management application 101 determines that communication between the browser 102 and the device 300 is possible, and performs redirection to the device 300 (corresponding to the step S1-7 in FIG. 10). On the other hand, when the device 300 does not incorporate a Web server, the device management application 101 acquires device information from the device 300, using the SNMP protocol (corresponding to the steps S1-8 and S1-9 in FIG. 10) (see FIG. 8 of Japanese Patent Laid-Open Publication No. 2003-330824).

If neither the browser 102 nor the device 300 is operating on IPv4, the process proceeds to a step S2-3, wherein the device management application 101 checks whether the IP version of the browser 102 is different from that of the device 300. That the IP version is different between the browser 102 and the device 300 means that the browser 102 uses only IPv4 and the device 300 uses only IPv6 (second protocol), or vice versa.

If the IP version is different between the browser 102 and the device 300, the process proceeds to the step S1-8 in FIG. 10, wherein the device management application 101 acquires information from the device 300. If the browser 102 and the device 300 are both operating on IPv6, the process proceeds to a step S2-4, wherein the device management application 101 checks whether all of the respective IPv6 addresses of the browser 102, the device management application 101, and the device 300 have the same prefix (subnet prefix).

A comparison between the prefixes is performed by comparing the values of the network address parts (subnet prefixes), each formed by the most significant 64 bits, of the respective IPv6 addresses. If the IPv6 addresses of the browser 102, the device 300, and the device management application 101 have the same prefix, the device management application 101 determines that the browser 102, the device 300, and the device management application 101 exist on the same network and therefore communication between the three is possible. Then, the process proceeds to the step S1-7 in FIG. 10, wherein the device management application 101 sends the redirect request to the browser 102 so as to redirect the browser 102 to the address of the device 300 (second transmission process).

If the IPv6 addresses of the browser 102, the device 300, and the device management application 101 have different prefixes, the process proceeds to a step S2-5, wherein the device management application 101 checks whether the IPv6 addresses of the browser 102 and the device 300 have the same prefix. If these IPv6 addresses have the same prefix, the device management application 101 determines that the browser 102 and the device 300 exist on the same network and therefore communication between the two is possible. Then, the process proceeds to the step S1-7 in FIG. 10, wherein the device management application 101 sends the redirect request to the address of the device 300 to the browser 102.

If the IPv6 addresses of the browser 102 and the device 300 have different prefixes, the process proceeds to a step S2-6, wherein the device management application 101 checks whether the IPv6 addresses of the device management application 101 and the device 300 have the same prefix. If these IPv6 addresses have the same prefix, it can be judged that the device management application 101 and the device 300 exist on the same network. Therefore, the device management application 101 determines that the browser 102 which can communicate with the device management application 101 can also communicate with the device 300. Then, the process proceeds to the step S1-7 in FIG. 10, wherein the device management application 101 sends the redirect request to the address of the device 300 to the browser 102.

If the IPv6 addresses of the device management application 101 and the device 300 have different prefixes, the process proceeds to a step S2-7, wherein the device management application 101 checks whether the IPv6 addresses of the browser 102 and the device management application 101 have the same prefix. If the IPv6 addresses have the same prefix, the flow process proceeds to a step S2-8 where the device management application 101 executes a first determination process. If the IPv6 addresses do not have the same prefix, the process proceeds to a step S2-9.

In the step S2-9, the device management application 101 acquires routing information on the device 300 using the SNMP protocol. Routing information is information on routes concerning packet delivery destinations, which is stored in a network apparatus, such as a router or the like device. In the case of IPv6, a network address table is stored as the routing information.

In the following step S2-10, the device management application 101 checks whether the routing information contains an IPv6 address having a prefix which makes possible communication between the browser 102 and the device 300. If the routing information on the device 300 contains the network address of the browser 102, the device 300 can directly send a packet to the browser 102. Therefore, it can be judged that communication between the device 300 and the browser 102 is possible.

If the routing information contains an IPv6 address having a prefix which makes possible communication between the browser 102 and the device 300, the process proceeds to the step S1-7, wherein the device management application 101 requests the browser 102 to redirect to the IPv6 address of the device 300 having the prefix that makes communication with the browser 102 possible.

If the routing information contains no IPv6 address having a prefix which makes possible communication between the browser 102 and the device 300, the process proceeds to a step S2-11, wherein the device management application 101 checks whether to execute a second determination process. If it is required to execute the second determination process, the present process proceeds to a step S2-12, wherein the device management application 101 executes the second determination process. The second determination process will be described in detail hereinafter. If it is not required to execute the second determination process, the present process proceeds to the step S1-8 in FIG. 10, wherein the device management application 101 acquires information from the device 300.

Next, a description will be given of two other examples of processing executed in the steps S2-9 et seq.

In the step S2-7, as described hereinabove, it is checked whether the IPv6 addresses of the browser 102 and the device management application 101 have the same prefix. If the IPv6 addresses do not have the same prefix, the device management application 101 may carry out the following processing executed by changing the acquisition destination of the routing information, in place of the processing in the steps S2-9 to S2-12. The processing will be described as a first processing example and a second processing example.

The first processing example acquires the routing information from the client apparatus 200, and is executed as follows:

If it is determined in the step S2-7 that the IPv6 addresses do not have the same prefix, the device management application 101 acquires routing information on the client apparatus 200 on which the browser 102 is operating, using the SNMP protocol. Then, the device management application 101 checks whether the routing information contains a prefix that makes possible communication between the browser 102 and the device 300.

When the routing information on the client apparatus 200 on which the browser 102 is operating contains the network address of the device 300, the browser 102 can directly send a packet back to the device 300. Therefore, it can be judged that the browser 102 can communicate with the device 300.

If the routing information contains a prefix that makes possible communication between the browser 102 and the device 300, the device management application 101 requests the browser 102 to redirect to the IPv6 address of the device 300, which has the prefix that makes communication with the browser 102 possible (see S2-7). If the routing information does not contain a prefix that makes possible communication between the browser 102 and the device 300, the device management application 101 checks whether to execute the second determination process. If it is determined that the second determination process is required to be executed, the device management application 101 executes the second determination process, described in detail hereinafter. If it is not determined that the second determination process is required to be executed, the device management application 101 acquires information from the device 300 (see step S1-8).

The second processing example acquires the routing information from a router and is executed as follows:

If it is determined in the step S2-7 that the same prefix does not exist, the device management application 101 acquires routing information from the router. Then, the device management application 101 checks whether the routing information contains an IPv6 address having a prefix that makes possible communication between the browser 102 and the device 300. When the routing information from the router contains the prefix of the browser 102 and that of the device 300 and hence when data transfer between the browser 102 and the device 103 is possible, it can be determined that communication between the browser 102 and the device 300 is possible.

If the routing information contains an IPv6 address having a prefix that makes possible communication between the browser 102 and the device 300, the device management application 101 carries out the processing in the step S1-7. If not, the device management application 101 checks whether to execute the second determination process, and then executes the same processing as in the first processing example.

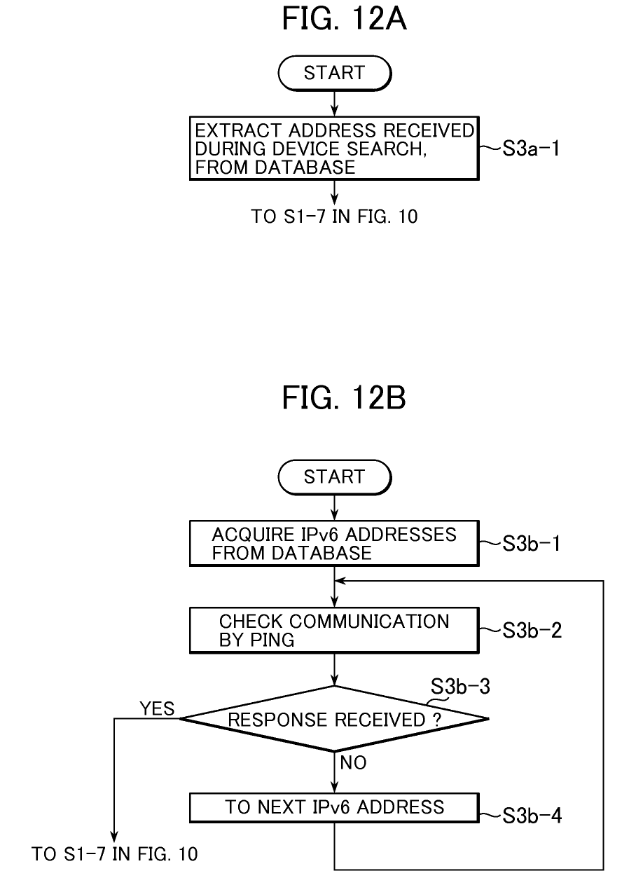

Next, details of the first determination process will be described with reference to FIGS. 12A and 12B.

FIGS. 12A and 12B are flowcharts showing details of the first determination process (S2-8) in FIG. 11. FIG. 12A shows a first example, and FIG. 12B shows a second example. The device management application 101 executes one of the processes shown in FIGS. 12A and 12B as the first determination process.

The first example, shown in FIG. 12A, of the first determination process is executed as follows:

First, in a step S3a-1, the device management application 101 acquires an IPv6 address of the device 300, which was received as the source address of a response packet during the device search, from the database 508. Then, the process proceeds to the step S1-7 in FIG. 10, wherein the device management application 101 requests the browser 102 to redirect to the address.

The second example, shown in FIG. 12B, of the first determination process is executed as follows:

First in a step S3b-1, the device management application 101 acquires all IPv6 addresses set for the device 300 from the database 508. Next, in a step S3b-2, the device management application 101 sends a PING packet to the device 300 using one of the IPv6 addresses, and then checks in a step S3b-3 whether a response has been received from the device 300.

If a response has been received from the device 300, the process proceeds to the step S1-7 in FIG. 10, wherein the device management application 101 requests the browser 102 to redirect to the IPv6 address from which the response has been received. If there has been received no response from the device 300, the process proceeds to a step S3b-4, wherein the device management application 101 carries out communication check by a PING packet, using the following one of the IPv6 addresses. The IPv6 addresses acquired from the database 508 contains an address used in communication during the device search, and hence at least one IPv6 address of the device 300 which makes possible communication between the device management application 101 and the device 300 is contained in the database 508.

The first determination process is executed when the IPv6 addresses of the browser 102 and the device management application 101 have the same prefix. In this case, the browser 102 and the device management application 101 exist on the same network. When communication between the device management application 101 and the device 300 is possible, it is determined that the browser 102 existing on the same network can also communicate with the device 300.

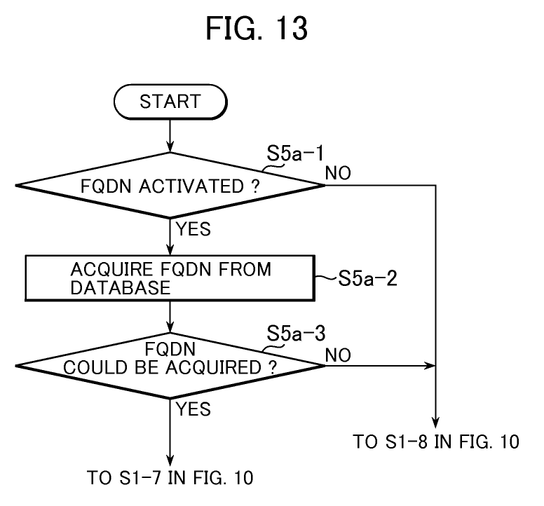

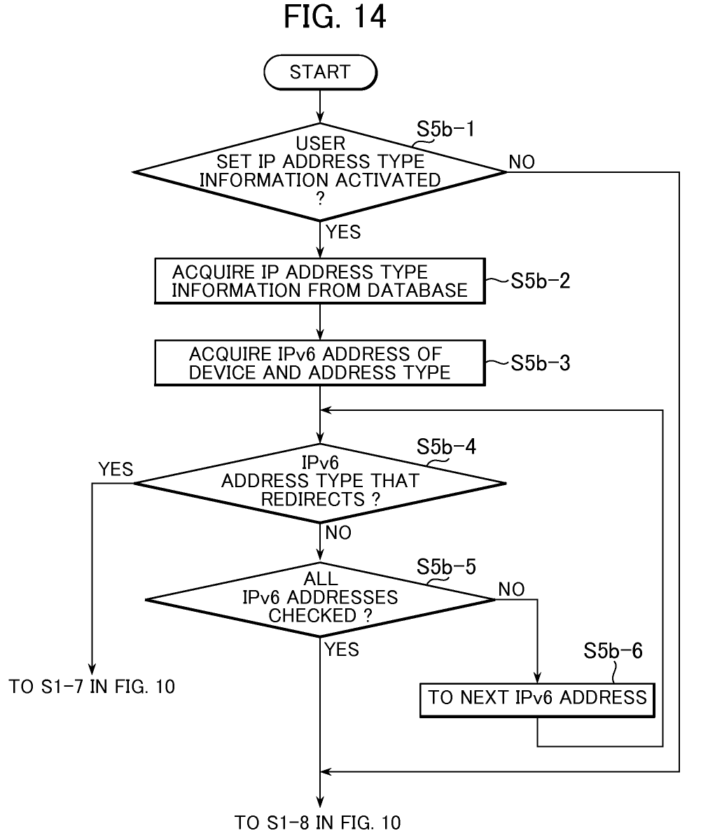

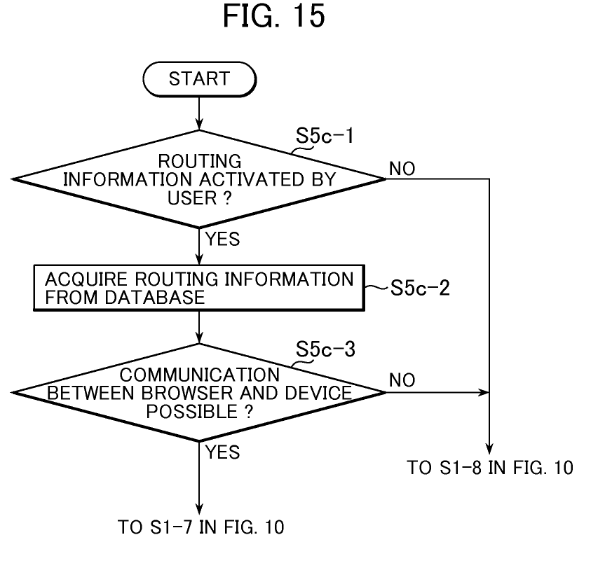

Next, the second determination process will be described with reference to FIGS. 13, 14, and 15. FIGS. 13, 14, and 15 are flowcharts showing details of the second determination process (S2-12) in FIG. 11. FIG. 13 shows a first example, FIG. 14 shows a second example, and FIG. 15 shows a third example. The device management application 101 carries out one of the processes shown in FIGS. 13, 14, and 15, as the second determination process. The second determination process is executed in a case where settings are so configured to execute the second determination process, by the user in advance.

The first example, shown in FIG. 13, of the second determination process is executed as follows:

First, in a step S5a-1, the device management application 101 checks whether in the request for jumping to the RUI of the device 300, the use of a FQDN (Fully Qualified Domain Name) for user's setting has been activated in advance by the user. The FQDN is a name uniquely identifying a network device, and is expressed e.g. as “pc123.abcd.com”.

If the use of an FQDN has not been activated, the process proceeds to the step S1-8 in FIG. 10, wherein the device management application 101 acquires information from the device 300. If the use of an FQDN has been activated, the process proceeds to a step S5a-2, wherein the device management application 101 acquires the FQDN of the device 300 stored during the device search, from the database 508.

In a step S5a-3, the device management application 101 determines whether the FQDN has been successfully acquired. If it is determined that the FQDN has been successfully acquired, the process proceeds to the step S1-7 in FIG. 10, wherein the device management application 101 sends a redirect request to the browser 102 so as to redirect the same to the device 300 using the FQDN. If it is determined that the FQDN has not been successfully acquired, the process proceeds to the step S1-8 in FIG. 10, wherein the device management application 101 acquires information from the device 300.

The second example, shown in FIG. 14, of the second determination process is executed as follows:

First, in a step S5b-1, the device management application 101 checks whether in the request for jumping to the RUI of the device 300, the use of IPv6 address type information for user's setting has been activated in advance by the user. If the use of IPv6 address type information has not been activated, the process proceeds to the step S1-8 in FIG. 10, wherein the device management application 101 acquires information from the device 300.

If the use of IPv6 address type information has been activated, the process proceeds to a step S5b-2, wherein the device management application 101 acquires the IPv6 address type information from the database 508. In a step S5b-3, the device management application 101 acquires an IPv6 address of the device 300 and its address type from the database 508.

In the following step S5b-4, the device management application 101 checks whether the acquired IPv6 address is of a type that redirects. If the acquired IPv6 address is of a type that redirects, the process proceeds to the step S1-7 in FIG. 10, wherein the device management application 101 sends a redirect request to the browser 102 so as to redirect the same to the acquired IPv6 address of the device 300.

If the acquired IPv6 address is not of a type that redirects, the process proceeds to a step S5b-5, wherein the device management application 101 determines whether all the IPv6 addresses of the device 300 have been checked. If not all the IPv6 addresses of the device 300 have been checked, the process proceeds to a step S5b-6, wherein the device management application 101 selects a next IPv6 address from the list of IPv6 addresses of the device 300.

If all the IPv6 addresses of the device 300 have been checked, the process proceeds to the step S1-8 in FIG. 10, wherein the device management application 101 acquires information from the device 300. The IPv6 address type information for user's setting has a default value for a type that redirects.

The third example, shown in FIG. 15, of the second determination process is executed as follows:

First, in a step S5c-1, the device management application 101 checks whether in the request for jumping to the RUI of the device 300, the use of routing information for user's setting has been activated in advance by the user. If the use of routing information has not being activated, the process proceeds to the step S1-8 in FIG. 10, wherein the device management application 101 acquires information from the device 300.

If the use of routing information has been activated, the process proceeds to a step S5c-2, wherein the device management application 101 acquires the routing information set by the user from the database 508. In the following step S5c-3, the device management application 101 determines whether communication between the browser 102 and the device 300 using the routing information set by the user is possible. If it is determined that communication between them is possible, the process proceeds to the step S1-7 in FIG. 10, wherein the device management application 101 sends a redirect request to the browser 102 to redirect the same to the device 300. If it is determined that it is impossible to perform the communication, the process proceeds to the step S1-8, wherein the device management application 101 acquires information from the device 300.

The present embodiment provides the following advantageous effects:

When the browser 102 is attempts to access the client apparatus 200 to the Web server incorporated in the device 300 to display such a RUI screen as shown in FIG. 8, the access is made via the device management application 101. At this time, the device management application 101 makes a comparison between the address of the client apparatus 200 on which the browser 102 is operating and the address of the device 300 in which the RUI exists (S12). Then, the result of the comparison shows that communication between the browser 102 and the device 300 is impossible (e.g. if the IP version of the browser 102 and that of the device 300 are different from each other), the following processing is executed: The device management application 101 acquires information from the device 300, and then generates such a device detail screen as shown in FIG. 9, based on the information acquired from the device 300, followed by sending data of the generated screen to the browser 102.

This makes it possible to display the device detail screen on the client apparatus 200 in place of the RUI screen, without displaying a communication error screen even in the environment where the IP version of the browser 102 and that of the device 300 are different from each other.

It should be noted that although in the present embodiment, whether the client apparatus and the device use the same protocol is determined based on the IP addresses of the two, other information indicating communication protocols than the addresses may be acquired so as to perform the determination.

A second embodiment of the present embodiment is so configured that in a network environment where a browser and a device are operating on IPv6, an address which makes possible communication between the browser and the device can be selected from a plurality of IPv6 addresses set for the device. The second embodiment is configured similarly to the first embodiment in the other respects. Therefore, the corresponding elements are denoted by identical reference numerals, and description thereof is omitted.

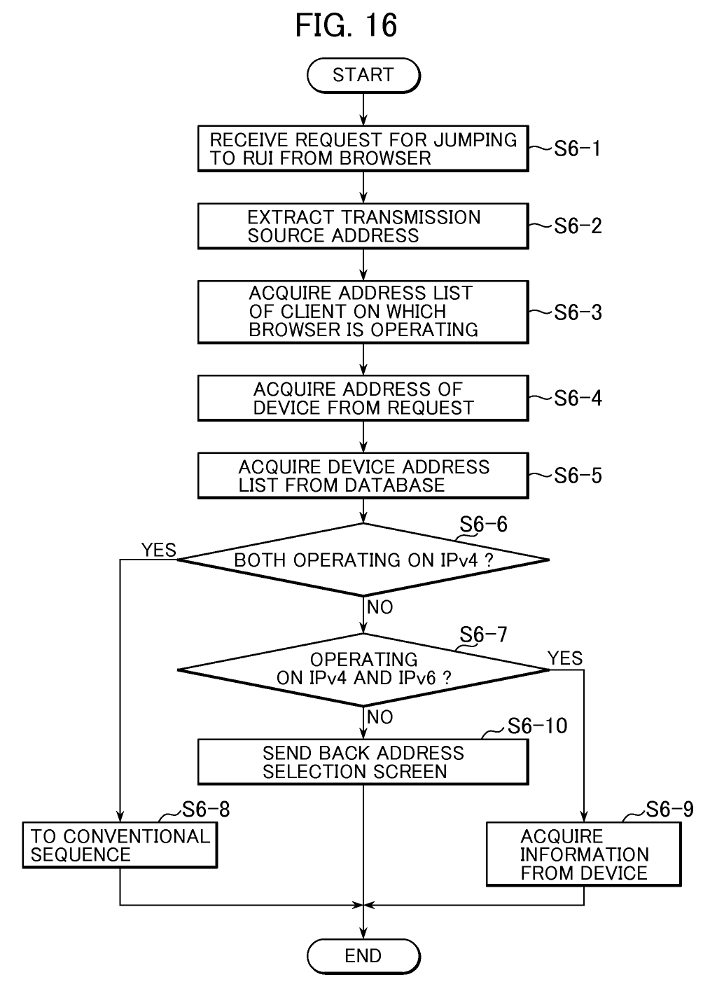

FIG. 16 is a flowchart of the outline of a device management process which is executed by the device management application 101 installed in the network device management apparatus 100 according to the second embodiment of the present invention.

Processing executed in steps S6-1 to S6-5 in FIG. 16 is identical to that executed in the steps S1-1 to S1-5, and hence description thereof is omitted.

In the step S6-6, the device management application 101 checks whether the browser 102 and the device 300 are both operating on IPv4. If the browser 102 and the device 300 are both operating on IPv4, the process proceeds to a step S6-8, wherein the device management application 101 executes the above-described conventional sequence, followed by terminating the present process.

If neither the browser 102 nor the device 300 is not operating on IPv4, the process proceeds to a step S6-7, wherein the device management application 101 checks whether the IP version of the browser 102 is different from that of the device 300. If the IP version of the browser 102 is different from that of the device 300, the device management application 101 proceeds to a step S6-9.

In the step S6-9, the device management application 101 acquires device information including e.g. status information and installation location information, using a protocol, such as SNMPv1, SNMPv3, or Web service, from the device 300. At this time, the device management application 101 uses an address which the device 300 used for sending back a response during the device search as described in the first embodiment.

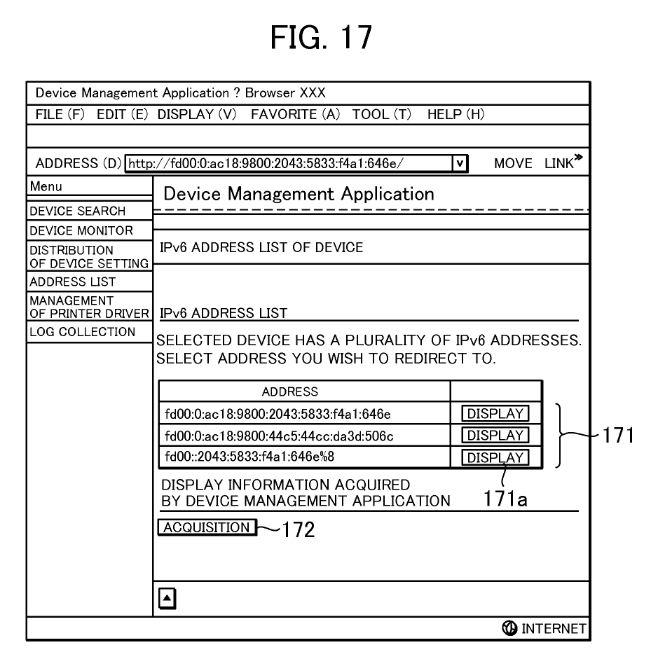

If the browser 102 and the device 300 are both operating on IPv6, the process proceeds to a step S6-10, wherein the device management application 101 generates HTML information for displaying an address selection screen, shown in FIG. 17 by way of example, as a screen for use in selecting an address from a plurality of addresses set for the device 300.

Thereafter, the device management application 101 sends the generated address selection screen back to the browser 102. The browser 102 having received the HTML information can display the address selection screen.

FIG. 17 is a view of an example of the address selection screen.

As shown in FIG. 17, on the address selection screen are displayed a list display area 171 for displaying an address list of a selected device 300 and an “acquisition” button 172 for use in acquisition of information from the device 300 by the device management application 101. Further, in the list display area 171, there are displayed “display” buttons 171a in association with respective addresses.

When one of the “display” buttons 171a in the list display area 171 is pressed, redirection is performed using an associated address, whereby the RUI screen can be displayed. Further, when the “acquisition” button 172 is pressed, information concerning the device is acquired by the device management application 101.

When the browser 102 attempts to access the Web server in the device 300 to display the RUI screen (see FIG. 8), if the browser 102 and the device 300 are both operating on IPv6, the following processing is executed: The device management application 101 generates an address selection screen and sends data of the generated screen back to the browser 102.

This makes it possible to display the address selection screen (see FIG. 17) on the client apparatus 200 without displaying a communication error screen even in the environment where the browser 102 and the device 300 are both operating on IPv6. This enables the IT administrator 103 to select a communicable address from a plurality of IPv6 addresses set for the device 300, using the address selection screen, and then perform redirection to thereby display the RUI screen.

A third embodiment of the present invention is distinguished from the first embodiment in that a proxy exists on the network system shown in FIG. 1, and hence the following description will be given of a sequence executed in this case. The third embodiment is configured similarly to the first embodiment in the other respects. Therefore, the corresponding elements are denoted by identical reference numerals, and description thereof is omitted.

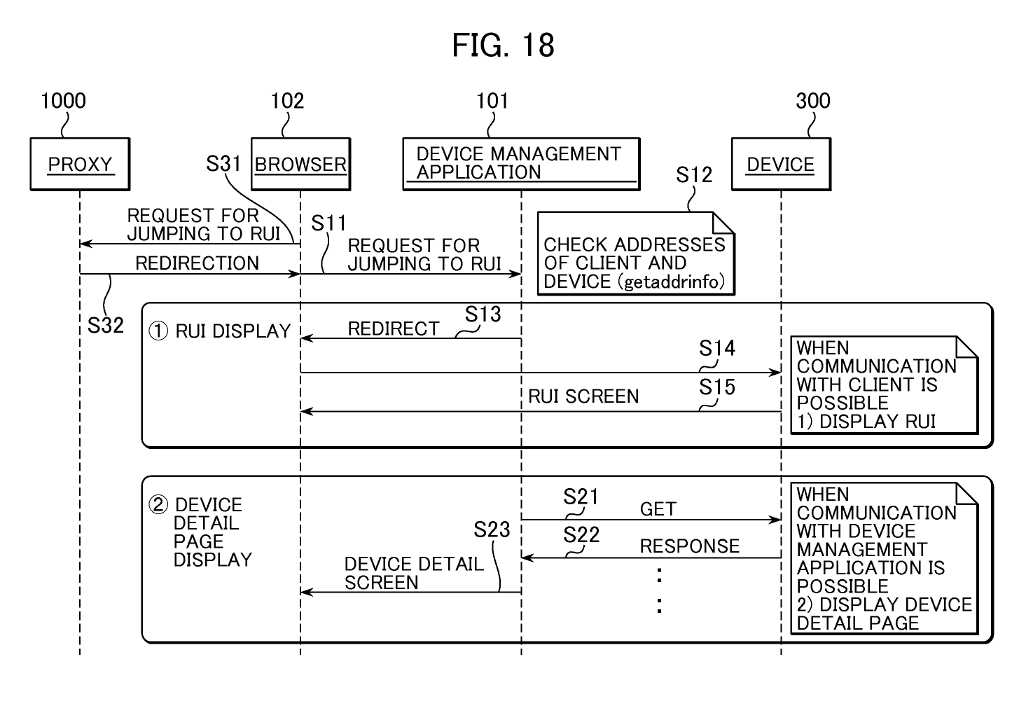

FIG. 18 is a sequence diagram of the sequence of operations of the network system including the network device management apparatus 100 according to the third embodiment of the present invention. The elements and steps identical to those in FIG. 7 are denoted by identical reference numerals and step numbers, and description thereof is omitted.

On the browser 102, there is displayed a device list in which devices to be managed are listed. The IT administrator accesses the Web server incorporated in the specific device 300, so as to refer to detail information on the device 300, and attempts to cause the Web server to display the RUI.

At this time, the browser 102 sends a request for jumping to the RUI to the device management application 101 via a proxy 1000 (S31). The proxy 1000 redirects the request from the browser 102 to the device management application 101 (S32).

Then, as in the description of FIG. 7, the steps S11 and S12 are executed, whereafter the steps S13 to S15 or S21 to S23 are executed.

According to the present embodiment, even when a proxy exists, it is possible to obtain the same advantageous effect as provided by the first embodiment.

It is to be understood that the present invention may also be accomplished by supplying a system or an apparatus with a storage medium in which a program code of software, which realizes the functions of any of the above described embodiments, is stored, and causing a computer (or CPU or MPU) of the system or apparatus to read out and execute the program code stored in the storage medium.

In this case, the program code itself read from the storage medium realizes the functions of any of the above described embodiments, and therefore the program code and the storage medium in which the program code is stored constitute the present invention.

Examples of the storage medium for supplying the program code include a floppy (registered trademark) disk, a hard disk, a magnetic-optical disk, an optical disk, such as a CD-ROM, a CD-R, a CD-RW, a DVD-ROM, a DVD-RAM, a DVD-RW, or a DVD+RW, a magnetic tape, a nonvolatile memory card, and a ROM. Alternatively, the program may be downloaded via a network.

Further, it is to be understood that the functions of any of the above described embodiments may be accomplished not only by executing the program code read out by a computer, but also by causing an OS (operating system) or the like which operates on the computer to perform a part or all of the actual operations based on instructions of the program code.

Further, it is to be understood that the functions of any of the above described embodiments may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2008-014056 filed Jan. 24, 2008, which is hereby incorporated by reference herein in its entirety.

What is claimed is:

1. A network device management apparatus communicably connected to a device and a client apparatus on a network, comprising:
a reception unit configured to receive an access request for access to the device from the client apparatus;
a first acquisition unit configured to acquire information which makes it possible to identify a communication protocol used by the client apparatus, when the access request is received by the reception unit;
a second acquisition unit configured to acquire information which makes it possible to identify a communication protocol used by the device, from the device;
a determination unit configured to determine, based on the information acquired by the first and second acquisition units, whether communication between the client apparatus and the device is possible;
a first transmission unit configured to send device information acquired from the device by the network device management apparatus to the client apparatus, when the determination unit does not determine that communication between the client apparatus and the device is possible; and
a second transmission unit configured to send an address for connection to the device to the client apparatus, when the determination unit determines that communication between the client apparatus and the device is possible.

2. The network device management apparatus according to claim 1, wherein when the communication protocol used by the client apparatus and the communication protocol used by the device are different from each other, the determination unit determines that communication between the client apparatus and the device is impossible.

3. The network device management apparatus according to claim 1, wherein when the client apparatus and the device are both operating on a specific protocol, the determination unit makes a comparison between prefixes assigned respectively to the client apparatus, the device, and the network device management apparatus, and determines, based on a result of the comparison, whether communication between the client apparatus and the device is possible.

4. The network device management apparatus according to claim 3, wherein when the client apparatus, the device, and the network device management apparatus have an identical prefix, the determination unit determines that communication between the client apparatus and the device is possible.

5. The network device management apparatus according to claim 3, wherein when the client apparatus and the device have an identical prefix, the determination unit determines that communication between the client apparatus and the device is possible.

6. The network device management apparatus according to claim 3, wherein when the network device management apparatus and the device have an identical prefix, the determination unit determines that communication between the client apparatus and the device is possible.

7. The network device management apparatus according to claim 3, wherein when the client apparatus and the network device management apparatus have an identical prefix, a source address defined by the specific protocol is extracted from the device information acquired from the device, and the second transmission unit sends the source address as an address of the device to the client apparatus.

8. The network device management apparatus according to claim 3, wherein when the client apparatus and the network device management apparatus have an identical prefix, an address defined by the specific protocol which makes communication with the device possible is extracted from the device information acquired from the device, using a specific packet, and the second transmission unit sends the extracted address as an address of the device to the client apparatus.

9. The network device management apparatus according to claim 3, wherein when the network device management apparatus, the client apparatus, and the device have respective different prefixes, routing information on the device is acquired, and it is determined, depending on whether the routing information contains an address defined by the specific protocol which makes possible communication between the client apparatus and the device, whether communication between the client apparatus and the device is possible.

10. The network device management apparatus according to claim 3, wherein when the network device management apparatus, the client apparatus, and the device have respective different prefixes, routing information on the client apparatus is acquired, and it is determined, depending on whether the routing information contains an address defined by the specific protocol which makes possible communication between the client apparatus and the device, whether communication between the client apparatus and the device is possible.

11. The network device management apparatus according to claim 3, wherein when the network device management apparatus, the client apparatus, and the device have respective different prefixes, routing information on a router is acquired, and it is determined, depending on whether the routing information contains an address defined by the specific protocol which makes possible communication between the client apparatus and the device, whether communication between the client apparatus and the device is possible.

12. The network device management apparatus according to claim 9, comprising a judgment unit configured to judge whether the device is assigned a name uniquely identifying the device on the network, and
wherein when the routing information on the device, the client apparatus, or the router does not contain the address defined by the specific protocol which make possible communication between the client apparatus and the device, it is determined, based on a result of the judgment by the judgment unit, whether communication between the client apparatus and the device is possible.

13. The network device management apparatus according to claim 9, wherein when the routing information on the device, the client apparatus, or the router does not contain the address defined by the specific protocol which makes possible communication between the client apparatus and the device, an address of the device and address type information are acquired from the device information acquired from the device, and it is determined, based on the address type information, whether communication between the client apparatus and the device is possible.

14. The network device management apparatus according to claim 9, wherein when the routing information on the device, the client apparatus, or the router does not contain the address defined by the specific protocol which makes possible communication between the client apparatus and the device, it is determined, using user set routing information, whether communication between the client apparatus and the device is possible.

15. The network device management apparatus according to claim 1, wherein the first acquisition unit acquires an address of the client apparatus, which is defined by the communication protocol used by the client apparatus, and
the second acquisition unit acquires an address of the device, which is defined by the communication protocol used by the device, and
wherein the determination unit determines, based on the address acquired by the first acquisition unit and the address acquired by the second acquisition unit, whether communication between the client apparatus and the device is possible.

16. The network device management apparatus according to claim 1, wherein the device information sent by the first transmission unit is HTML data generated based on the information acquired from the device, and the address sent by the second transmission unit is a URL for access to a Web server provided in the device.

17. A network device management apparatus including a device search unit that searches for a device on a network, and an information acquisition unit that acquires, from the device found by the device search unit, information on the device, the network device management apparatus being communicably connected to the device and a client apparatus on the network, comprising:
a unit configured to receive an access request for access to the device from the client apparatus;
a unit configured to acquire an address of the client apparatus, which is defined by a first protocol as a communication protocol used by the client apparatus or a second protocol obtained by updating a version of the first protocol, when the access request is received;
a unit configured to acquire a list of addresses of the device, which is defined by the first protocol or the second protocol used by the device, from the information on the device acquired by the information acquisition unit; and
a unit configured to make a comparison between the acquired address of the client apparatus and the addresses of the device, and send the acquired list of the addresses of the device to the client apparatus when the client apparatus and the device are both operating on the second protocol.

18. A method of controlling a network device management apparatus communicably connected to a device and a client apparatus on a network, comprising:
receiving an access request for access to the device from the client apparatus;
acquiring information which makes it possible to identify a communication protocol used by the client apparatus, when the access request is received;
acquiring information which makes it possible to identify a communication protocol used by the device, from the device;
determining, based on the acquired information which makes it possible to identify a communication protocol used by the client apparatus and the acquired information which makes it possible to identifying a communication protocol used by the device, whether communication between the client apparatus and the device is possible;
sending device information acquired from the device by the network device management apparatus to the client apparatus, when it is not determined that communication between the client apparatus and the device is possible; and
sending an address for connection to the device, to the client apparatus, when it is determined that communication between the client apparatus and the device is possible.

19. A network system including a device, a client apparatus, and a network device management apparatus on a network, the network device management apparatus being communicably connected to the device and the client apparatus,
wherein the network device management apparatus comprises:
a reception unit configured to receive an access request for access to the device from the client apparatus;
a first acquisition unit configured to acquire information which makes it possible to identify a communication protocol used by the client apparatus, when the access request is received by the reception unit;
a second acquisition unit configured to acquire information which makes it possible to identify a communication protocol used by the device, from the device;
a determination unit configured to determine, based on the information acquired by the first and second acquisition units, whether communication between the client apparatus and the device is possible;
a first transmission unit configured to send device information acquired from the device by the network device management apparatus to the client apparatus, when the determination unit does not determine that communication between the client apparatus and the device is possible; and
a second transmission unit configured to send an address for connection to the device to the client apparatus, when the determination unit determines that communication between the client apparatus and the device is possible.

20. A computer-readable storage medium storing a computer-executable process, the computer-executable process causing a computer to implement a method of controlling a network device management apparatus communicably connected to a device and a client apparatus on a network, the method comprising:
receiving an access request for access to the device from the client apparatus;
acquiring information which makes it possible to identify a communication protocol used by the client apparatus, when the access request is received;
acquiring information which makes it possible to identify a communication protocol used by the device, from the device;
determining, based on the acquired information which makes it possible to identify a communication protocol used by the client apparatus and the acquired information which makes it possible to identifying a communication protocol used by the device, whether communication between the client apparatus and the device is possible;
sending device information acquired from the device by the network device management apparatus to the client apparatus, when it is not determined that communication between the client apparatus and the device is possible; and
sending an address for connection to the device, to the client apparatus, when it is determined that communication between the client apparatus and the device is possible.
